(19) United States
(12) Patent Application Publication
(10) Pub. No.: US 2014/0122160 A1
(43) Pub. Date: May 1, 2014

(54) Optimized License Procurement

(71) Applicant: INTERNATIONAL BUSINESS MACHINES CORPORATION, Armonk, NY (US)

(72) Inventors: Nicholas C. Fuller, North Hills, NY (US); Hui Lei, Scarsdale, NY (US); Jian Qiu, Beijing (CN); Zhe Zhang, Elmsford, NY (US); Liangzhao Zeng, Mohegan Lake, NY (US)

(73) Assignee: INTERNATIONAL BUSINESS MACHINES CORPORATION, Armonk, NY (US)

(21) Appl. No.: 13/662,065

(22) Filed: Oct. 26, 2012

Related U.S. Application Data
(63) Continuation of application No. 13/661,673, filed on Oct. 26, 2012.

(51) Int. Cl. G06Q 10/06

(52) U.S. Cl. 705/7.25

(57) ABSTRACT

Techniques, a system and an article of manufacture for automatically determining a license procurement decision include identifying one or more license types for a software product, identifying, for each license type, one or more types of hardware configuration and software usage information to collect for a product license procurement decision, collecting said identified one or more types of hardware configuration and software usage information, populating a license decision matrix with said collected one or more types of hardware configuration and software usage information, and automatically generating a license procurement decision for the product based on analysis of the license decision matrix.

### CROSS-REFERENCE TO RELATED APPLICATIONS

This application is a continuation of U.S. patent application Ser. No. 13/661,673, filed Oct. 26, 2012, and incorporated by reference herein.

### FIELD OF THE INVENTION

Embodiments of the invention generally relate to information technology, and, more particularly, to license management.

### BACKGROUND

License procurement decisions are made, for example, when installing new software products, as well as when increasing the inventory of existing software products. Many products can be covered by multiple license types. Also, some license types are based on hardware assets such as servers, cores, processors, etc., while other license types are based on software usage by users, subscribers, etc.

In many instances, account teams and enterprises seek and receive suggestions from vendors regarding what licenses to buy, and a primary concern is often ease of management. However, existing approaches for license procurement rely on manual efforts to make procurement decisions, which can be expensive and inaccurate. Accordingly, a need exists for a systematic and automatic mechanism to make procurement decisions to minimize licensing costs.

### SUMMARY

In one aspect of the present invention, techniques for optimized license procurement are provided. An exemplary computer-implemented method for automatically generating a license procurement decision can include steps of identifying one or more license types for a software product, identifying, for each license type, one or more types of hardware configuration and software usage information to collect for a product license procurement decision, collecting said identified one or more types of hardware configuration and software usage information, populating a license decision matrix with said collected one or more types of hardware configuration and software usage information, and automatically generating a license procurement decision for the product based on analysis of the license decision matrix.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example embodiment, according to an aspect of the invention;

FIG. 2 is a diagram illustrating an example interface for template generation, according to an aspect of the invention;

FIG. 3 is a diagram illustrating an example interface for information collection, according to an aspect of the invention;

FIG. 4 is a flow diagram illustrating techniques in accordance with an embodiment of the invention;

FIG. 5 is a flow diagram illustrating techniques for automatically generating a license procurement decision, according to an embodiment of the invention; and

FIG. 6 is a system diagram of an exemplary computer system on which at least one embodiment of the invention can be implemented.

### DETAILED DESCRIPTION

As described herein, an aspect of the present invention includes optimizing license procurement. At least one embodiment of the invention includes facilitating licensing experts to define entries (for example, columns) of a license decision matrix, and asset management teams to populate entries (for example, rows) of the matrix. In at least one example embodiment of the invention, the number of columns is equal to the number of license types that can be used on the product, and the number of rows is equal to the summation of the number of installations of the product and the number of physical and virtual computers running the product. Additionally, as detailed herein, an automatic engine makes procurement decisions, for example, to optimize licensing costs based on the generated license decision matrix.

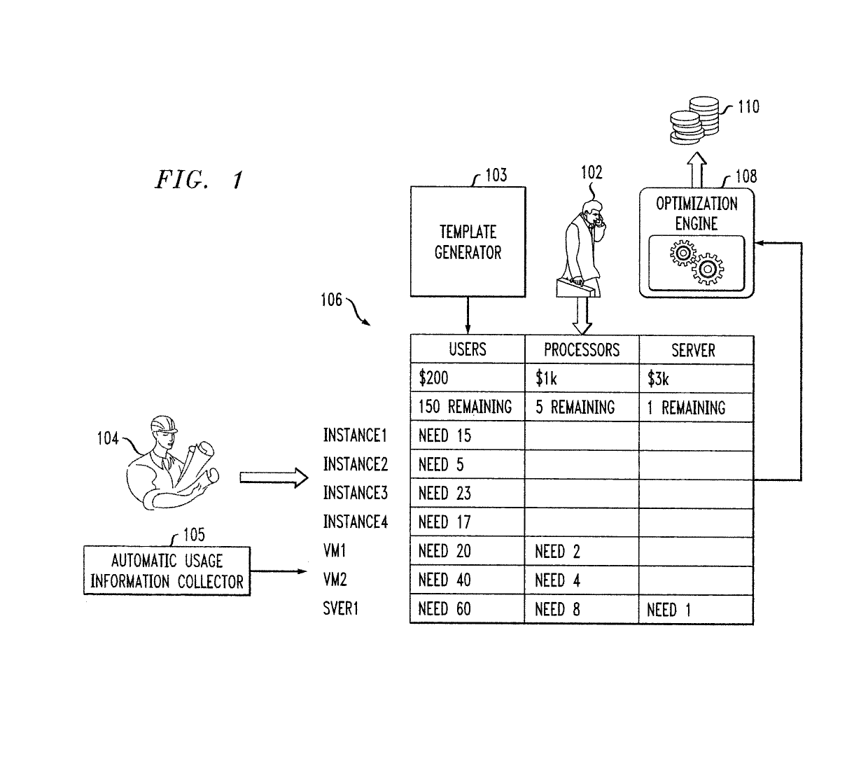

FIG. 1 is a diagram illustrating an example embodiment, according to an aspect of the invention. By way of illustration, FIG. 1 depicts license experts or practitioners 102, an enterprise entity and/or information technology (IT) management teams 104, a license decision matrix 106 and an optimization engine component 108. As described herein, license experts 102 define the template of the license decision matrix 106. Defining the template can include, for example, identifying the possible license types and unit price of each type, as well as identifying the container(s) that each license type covers. In at least one embodiment of the invention, the license expert defines the matrix template based on his/her understanding of the license terms and conditions. By way of example, a user license type covers instances, virtual machines (VMs) and physical servers, while a processor license type covers VMs and physical servers.

As also used above and herein, a container, or product container, refers to any software or hardware asset that can be entitled by a software license. For example, a container can be a physical computer, a logical partition, a virtual computer, or a software installation instance.

Additionally, IT management teams 104 populate the rows of the license decision matrix 106. Information to be included in the rows of the license decision matrix 106 can include, for example, hardware configuration of each deployed asset, usage information (users, subscribers, etc.), and remaining licenses. By way of example, the IT management team can use software and hardware discovery tools to determine the information to enter into the rows.

Further, as detailed herein, the optimization engine component 108 takes the created license decision matrix 106 and generates an optimized license procurement decision 110.

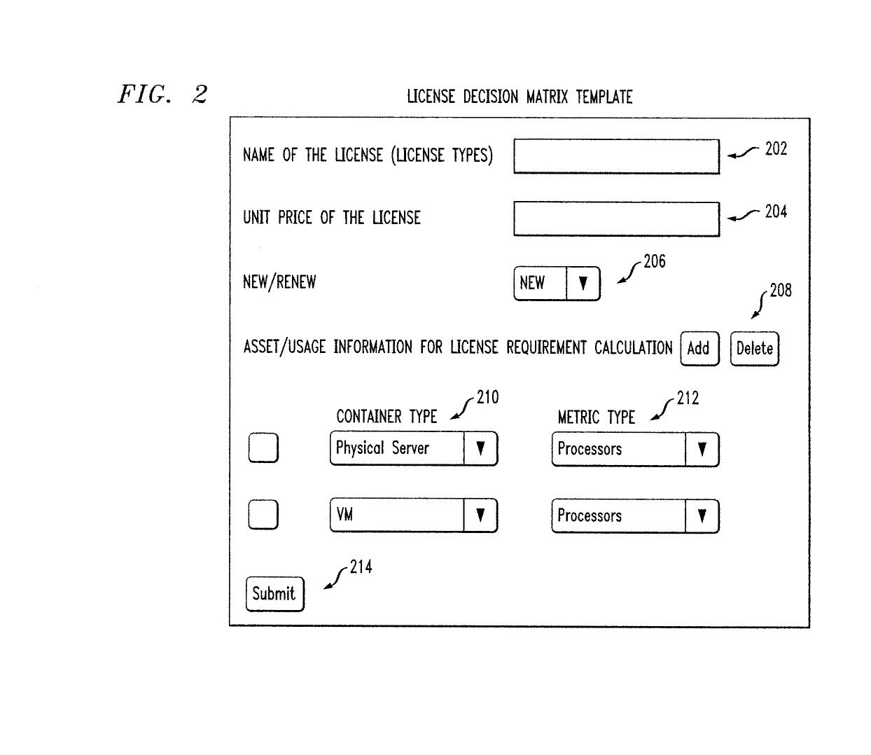

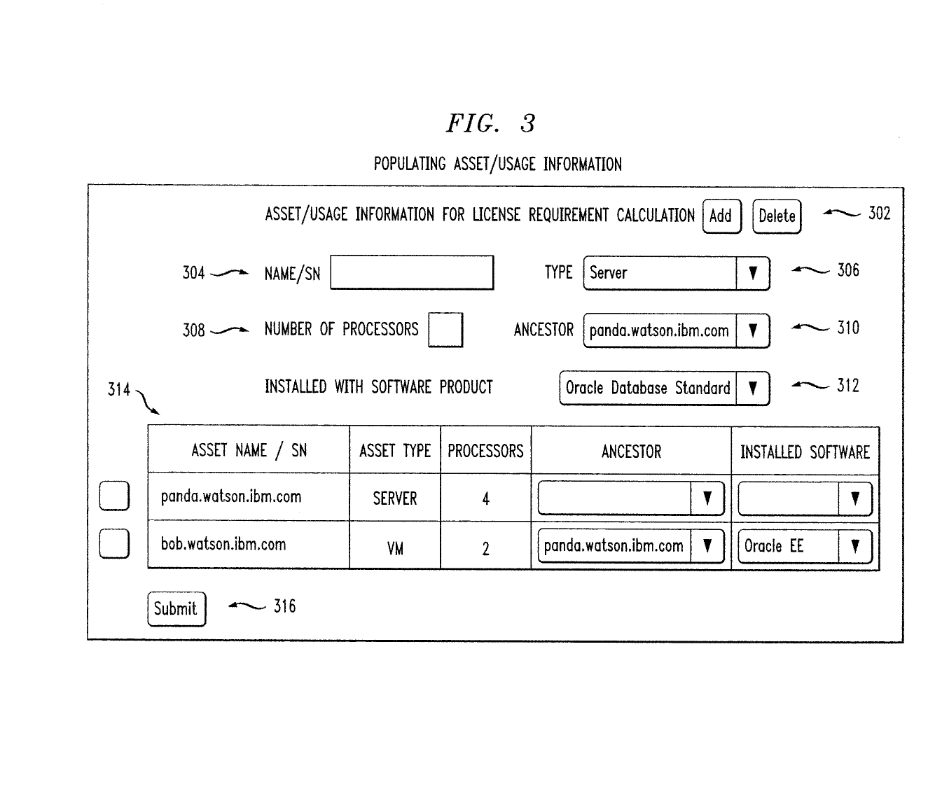

As also depicted in FIG. 1, at least one embodiment of the invention can include a template generator component 103, which defines the types of information to collect for a particular software product, as well as an automatic usage information collector component 105, which populates the template defined by the template generator. In connection with the template generator component 103 and automatic usage information collector component 105, at least one embodiment of the invention can include interfaces that would be used by license experts 102 and IT management teams 104. Examples of such interfaces are depicted in FIG. 2 and FIG. 3.

FIG. 2 is a diagram illustrating an example interface for template generation, according to an aspect of the invention. By way of illustration, the example interface of

FIG. 2 depicts a query for the name of the license (License Types) 202, and a query for the unit price of the license 204. Additionally, FIG. 2 depicts a new or renew pull-down selector query 206, as well as asset/usage information for license requirement calculation addition or deletion function 208. Further, FIG. 2 depicts container type pull-down selector queries 210, metric type pull-down selector queries 212, and a submit function 214.

FIG. 3 is a diagram illustrating an example interface for information collection, according to an aspect of the invention. By way of illustration, the example interface of FIG. 3 depicts asset/usage information for license requirement calculation addition or deletion function 302, a query for name 304, and a pull-down query for type 306. Additionally, FIG. 3 depicts a query for number of processors 308, a pull-down query for ancestor 310, and a pull-down query for installed software product 312. Further, FIG. 3 depicts a table 314 including information obtained from the above-noted queries, as well as a submit function 316.

Returning to FIG. 1, and as noted above, license experts 102 can define a template of the license decision matrix 106. Accordingly, in at least one embodiment of the invention, the license experts 102 enter multiple pieces of information into the license decision matrix 106. As noted herein, that information can include all license types that can be used on the product in question. For example, new purchases and renewals are treated as different license types due to different unit prices. The information can also include the unit price of each license type, as well as the asset and/or usage information needed for carrying out a license requirement calculation. Asset and/or usage information can include, for example, identification of the unit on which information is to be collected (server, logical partition (LPAR), VM, etc.), and identification of what information to collect (the number or processors, the number of users, etc.).

By way of example, a software vendor of the product can provide information such as noted above as part of the licensing agreement. Such information can, for instance, specify that for a particular edition product, two license types can be used: PROCESSOR and USER. Further, unit price of each type can be given with an explanation as to how to measure the license requirement for each license type.

Additionally, as illustrated in FIG. 1, IT management teams 104 populate the license decision matrix 106. In at least one embodiment of the invention, an IT management team 104 runs an automatic program that enters the following information into the matrix 106: the available amount of remaining licenses, the required quantity of each instance, the server and/or LPAR in each license type, and the containment relationships. For example, with respect to containment relationships, a product container A may contain another product container B if B is installed on A or runs on A. For instance, container A can be a physical machine and container B can be a virtual machine running on container A. Additionally, in at least one embodiment of the invention, an IT management team can insert information that is not covered by automatic scanning and discovery tools.

Further, as noted, the license optimization engine 108 solves the license decision matrix 106 and generates a license procurement decision 110 (for example, a decision that optimizes licensing costs). In at least one embodiment of the invention, the license optimization engine 108 generates customized solutions/decisions 110 based on the characteristics of the rows and columns (that is, based on the information contained therein) of the license decision matrix 106.

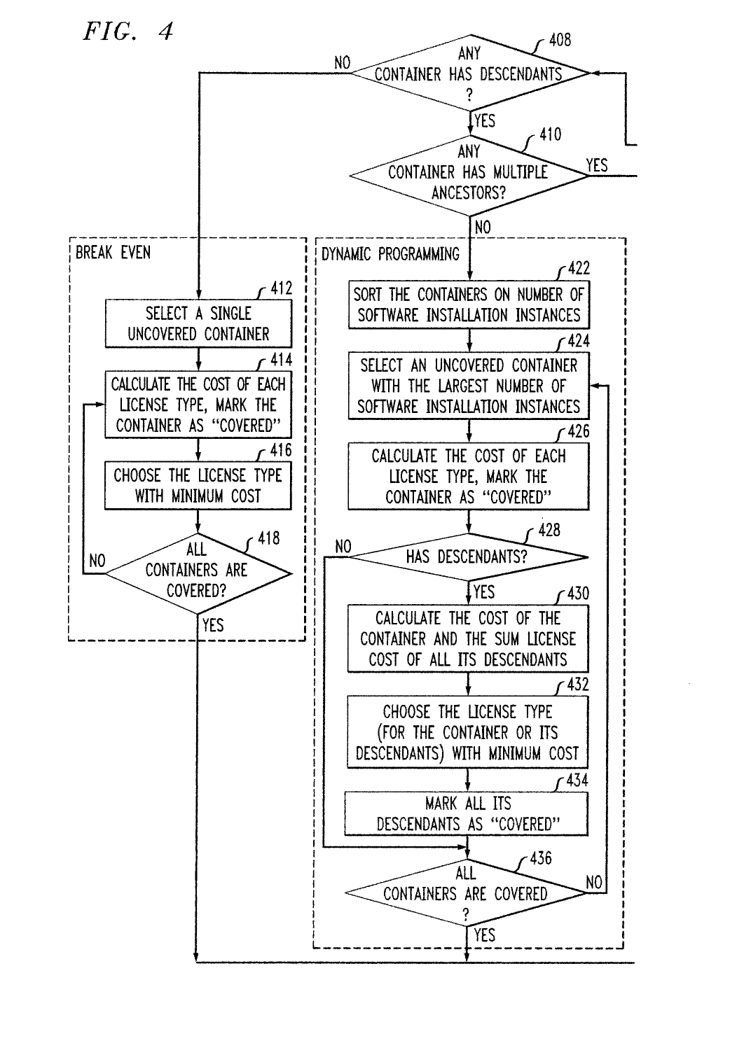

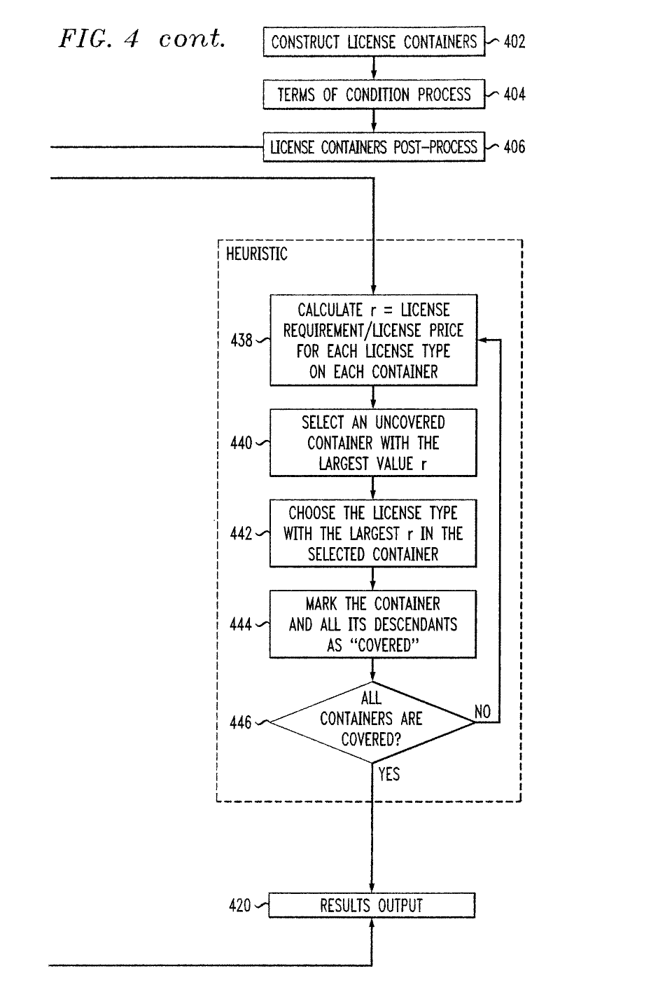

FIG. 4 is a flow diagram illustrating techniques in accordance with an embodiment of the invention. Step 402 includes constructing license containers, step 404 includes terms of condition processing, and step 406 includes license containers post-processing. Step 408 includes determining whether any container has descendants. If no (that is, no container has descendants), the sequence proceeds to step 412, which includes selecting a single uncovered container. Further, step 414 includes calculating the cost of each license type, and marking the container as “covered.” Step 416 includes choosing the license type with the lowest cost, and step 418 includes determining whether all containers are covered. If no (that is, not all containers are covered), the technique returns to step 412. If all containers are covered, step 420 includes outputting the results.

If there are containers that have descendants (as determined in step 408), step 410 includes determining whether any container has multiple ancestors. If no (that is, there is no container that has multiple ancestors), the technique proceeds to step 422, which includes sorting the containers based on the number of software installation instances. Step 424 includes selecting an uncovered container with the largest number of software installation instances, and step 426 includes calculating the cost of each license type, and marking the container as “covered.” Step 428 includes determining whether the container has a descendant. If no, the techniques proceed to step 436, described below. If yes, then step 430 includes comparing the cost of the container and the sum license cost of all of the container's descendants. Also, step 432 includes choosing the license type (for the container or its descendants) with the lowest cost, and step 434 includes marking the descendants as “covered.” Additionally, step 436 includes determining whether all containers are covered. If yes, the techniques proceed to outputting results in step 420. If no, the techniques return to step 424.

If there is a container with multiple ancestors (as determined in step 410), the techniques proceed to step 438, which includes calculating r=license requirement/license price for each license type on each container. Further, step 440 includes selecting an uncovered container with the largest r value, step 442 includes choosing the license type with the largest r value in the selected container, and step 444 includes marking the container and all of its descendants as “covered.” Additionally, step 446 includes determining whether all containers are covered. If yes, the techniques proceed to outputting results in step 420. If no, the techniques return to step 440.

By way of illustration, consider the following example scenarios. A first example scenario includes a decision matrix with one column, denoting one application license type. A solution to such a scenario can include counting the total required quantity in the license type identified in the one column, and the input required for such a solution would include the overall license requirement.

A second example scenario includes a decision matrix with multiple columns and non-overlapping rows. This indicates multiple license types, and that the coverage units do not contain or overlap with each other. A solution to such a scenario can include making independent decisions at each row, as well as counting the required quantity in each capacity type and selecting the most cost-efficient option. Input required for such a solution would include unit license requirements and/or prices.

By way of further illustration, consider the following example solution structure for the second example scenario. Assume that every row is a VM, and no row contains other rows. Each container can only be covered independently, and accordingly, there is a to break-even point based on an entitlement unit's license requirements in each capacity type. For example, for a given enterprise, based on the enterprise's price list, the break-even point may be a certain number of users and/or processors.

A third example scenario includes a decision matrix with multiple columns and rows, where the rows form a tree hierarchy. A solution to such a scenario can include determining an exact optimal solution in one pass of all rows (from the smallest to the largest). Specifically, for each row, the cost of covering itself can be compared with the cost of covering every sub-row. Input required for such a solution would include unit license requirements and/or prices, as well as containment relationships.

By way of further illustration, consider the following example solution structure for the third example scenario. Assume that some columns are VMs, and some columns are physical servers. All containers form a tree-hierarchy, and the minimal cost to cover a container is the smaller of the sum of all minimal costs to cover its direct descendants and the minimal cost to cover the container as a whole. Accordingly, in such an example, at least one embodiment of the invention would include iterating through all containers, from the smallest container to the largest container, and for each container, calculating the minimal cost to cover said container (as illustrated, for example, in FIG. 4).

A fourth example scenario includes a decision matrix with multiple rows and columns that intersect with each other. A solution to such a scenario can include using set-cover heuristics to determine approximate solutions, and selecting the entitlement with the most advantageous or desirable performance/price ratio. Input required for such a solution would include unit license requirements and/or prices, containment relationships, and a detailed installation distribution pattern. An installation distribution pattern can include, for example, the placement of each software installation instance and each VM, distribution of software users on different VMs and servers, etc.

By way of further illustration, consider the following example solution structure for the fourth example scenario. Assume that some columns are servers and some columns are subscribers, and that a software instance can be covered by either one of the containers containing it. Accordingly, in such an example, at least one embodiment of the invention would include selecting the entitlement with the most advantageous and/or desirable performance/price ratio until all software instances are covered. As used herein, performance refers to the number of covered software instances, and price refers to the coverage cost. Additionally, at least one embodiment of the invention includes updating the matrix and/or containment list after each entitlement with, for example, the license requirement and the size of each container (that is, the number of software installation instances on each container).

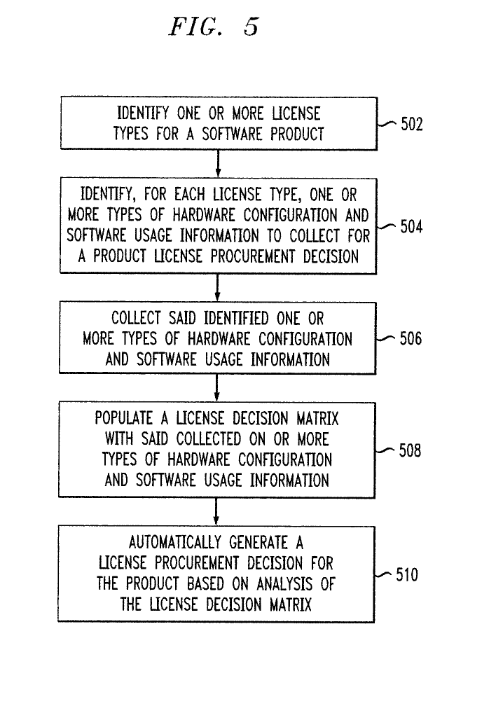

FIG. 5 is a flow diagram illustrating techniques for automatically generating a license procurement decision, according to an embodiment of the present invention. Step 502 includes identifying one or more license types for a software product. Step 504 includes identifying, for each license type, one or more types of hardware configuration and software usage information to collect for a product license procurement decision. As detailed herein, the product can be a software product. Additionally, the information can include at least one possible license type for the product (for example, a new license type and a renewal license type), a unit price for each license type, a required quantity of each instance in each license type, a license requirement of each product installation instance and/or each set of product installation instances, and asset and/or usage information pertaining to the license requirement. Further, the information can also include remaining capacity of a license, identification of one or more members of each set of product installation instances, and identification of at least one containment relationship.

Step 506 includes collecting said identified one or more types of hardware configuration and software usage information. The collecting step can include collecting the identified types of hardware configuration and software usage information from an information technology environment under consideration. For example, this can include collecting the number of servers, and the number of processors on each server from the information technology environment under consideration.

Step 508 includes populating a license decision matrix with said collected one or more types of hardware configuration and software usage information. Step 510 includes automatically generating a license procurement decision for the product based on analysis of the license decision matrix. The analysis of the license decision matrix can include, for example, categorizing the product into one of multiple pre-established license procurement decision categories. Additionally, analysis of the license decision matrix can include determining a most cost-effective licensing procurement decision.

The techniques depicted in FIG. 5 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 5 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

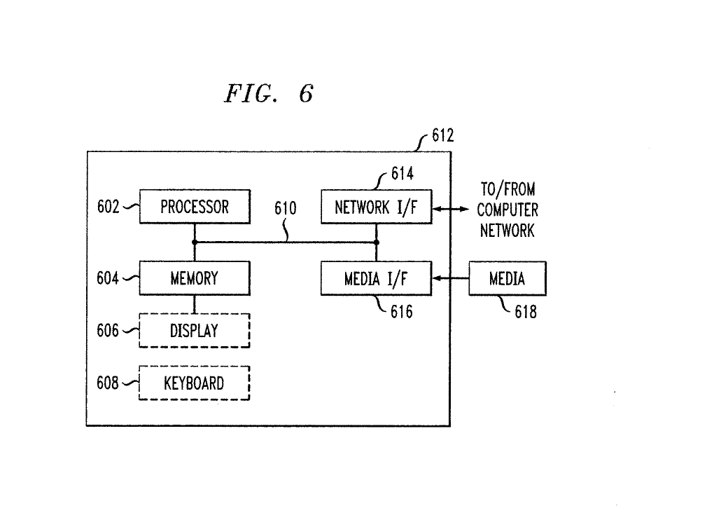

Additionally, an aspect of the present invention can make use of software running on a general purpose computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening non-public or public networks. Modems, cable modem and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

As noted, aspects of the present invention may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, automatically making license procurement decisions based on expert-defined entries in a license decision matrix.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An article of manufacture comprising a computer readable storage medium having computer readable instructions tangibly embodied thereon which, when implemented, cause a computer to carry out a plurality of method steps comprising:
identifying one or more license types for a software product;
identifying, for each license type, one or more types of hardware configuration and software usage information to collect for a product license procurement decision;
collecting said identified one or more types of hardware configuration and software usage information;
populating a license decision matrix with said collected one or more types of hardware configuration and software usage information; and
automatically generating a license procurement decision for the product based on analysis of the license decision matrix.

2. The article of manufacture of claim 1, wherein the product is a software product.

3. The article of manufacture of claim 1, wherein said one or more license types for a software product comprises at least one possible license type for the product.

4. The article of manufacture of claim 3, wherein said at least one possible license type comprises a new license type and a renewal license type.

5. The article of manufacture of claim 3, wherein said information comprises a unit price for each license type.

6. The article of manufacture of claim 3, wherein said information comprises a required quantity of each instance in each license type.

7. The article of manufacture of claim 1, wherein said information comprises a license requirement of each product installation instance and/or each set of product installation instances.

8. The article of manufacture of claim 7, wherein said information comprises asset and/or usage information pertaining to the license requirement.

9. The article of manufacture of claim 1, wherein said information comprises a remaining capacity of a license.

10. The article of manufacture of claim 1, wherein said information comprises identification of one or more members of each set of product installation instances.

11. The article of manufacture of claim 1, wherein said information comprises identification of at least one containment relationship.

12. The article of manufacture of claim 1, wherein said analysis of the license decision matrix comprises categorizing the product into one of multiple pre-established license procurement decision categories.

13. The article of manufacture of claim 1, wherein said analysis of the license decision matrix comprises determining a most cost-effective licensing procurement decision.

14. The article of manufacture of claim 1, wherein said identifying one or more types of hardware configuration and software usage information to collect is carried out via at least one human practitioner.

15. The article of manufacture of claim 1, wherein said populating a license decision matrix is carried out via at least one human entity.

16. The article of manufacture of claim 1, wherein said collecting comprises collecting said identified one or more types of hardware configuration and software usage information from an information technology environment under consideration.

17. The article of manufacture of claim 16, wherein said collecting comprises collecting a number of servers, and a number of processors on each server from the information technology environment under consideration.

18. A system for automatically generating a license procurement decision, comprising:
at least one distinct software module, each distinct software module being embodied on a tangible computer-readable medium;
a memory; and
at least one processor coupled to the memory and operative for:
identifying one or more license types for a software product;
identifying, for each license type, one or more types of hardware configuration and software usage information to collect for a product license procurement decision;
collecting said identified one or more types of hardware configuration and software usage information;
populating a license decision matrix with said collected one or more types of hardware configuration and software usage information; and
automatically generating a license procurement decision for the product based on analysis of the license decision matrix.

19. The system of claim 18, wherein said analysis of the license decision matrix comprises categorizing the product into one of multiple pre-established license procurement decision categories.

20. The system of claim 18, wherein said analysis of the license decision matrix comprises determining a most cost-effective licensing procurement decision.
